(19) United States
(12) Patent Application Publication
(10) Pub. No.: US 2008/0075271 A1
(43) Pub. Date: Mar. 27, 2008

(54) CONFIGURABLE PHONE OPTION TO INCREASE OR DECREASE RING TONE VOLUMES

(75) Inventors: James E. Bostick, Cedar Park, TX (US); Randolph M. Forlenza, Austin, TX (US); John P. Kaemmerer, Pflugerville, TX (US); Raghuraman Kalyanaraman, Austin, TX (US)

Correspondence Address: CANTOR COLBURN LLP - IBM AUSTIN, 20 Church Street, 22nd Floor, Hartford, CT, 06103, US

(73) Assignee: International Business Machines Corporation, Armonk, NY (US)

(21) Appl. No.: 11/530,221

(22) Filed: Sep. 8, 2006

(51) Int. Cl. H04M 3/00

(52) U.S. Cl. 379/418

(57) ABSTRACT

A ring tone controller and method is provided. The ring tone controller includes a linear and non-linear ring tone volume controller. The linear ring tone volume and the non-linear ring tone volume controller are adapted to controlling a volume of the ring tone signal over a predetermined user set period. The linear ring tone volume and the non-linear ring tone volume controller are also adapted to controlling a volume of the ring tone signal over a predetermined second user set period contiguous with the firs set period.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to signaling devices, and particularly to phones having ring tones.

2. Description of the Related Art

Before our invention, telephones have ring tones that can typically be preset by the user to a particular volume. Ringing cell phones can be annoying to surrounding people if the preset ring tone volume (phone calls received) is too loud for certain environments. This is especially true, for example, when the owner of the cell phone fumbles trying to answer the call, and others have to listen to the loud distraction. Conversely, sometimes, the ring tone is set too low for the environment. This can be annoying to the owner of the phone because that person may not hear the call; causing missed calls.

There needs to be an option to control the volume of the ring tone such that it can be set to increase or decrease in volume automatically, and to preset configurations. In addition, it should automatically adjust the volume within a predefined timeframe.

### SUMMARY OF THE INVENTION

The shortcomings of the prior art are overcome and additional advantages are provided through the provision of a ring tone controller.

In accordance with one embodiment of the present invention, a ring tone controller is provided. The ring tone controller includes a linear ring tone volume controller wherein the linear ring tone volume controller is adapted to linearly controlling a volume of the ring tone signal over a predetermined user set period. The linear ring tone volume controller is also adapted to linearly controlling another volume of the ring tone signal which is contiguous with the first ring tone volume.

The ring tone controller also includes a non-linear ring tone volume controller wherein the non-linear ring tone volume controller is adapted to non-linearly controlling the volume of the ring tone signal over set period. The non-linear ring tone volume controller is also adapted to non-linearly control another volume of the ring tone signal over another volume of the ring tone signal which is also contiguous with the first non-linear ring tone volume.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution which improves the usability of devices with sound signaling capability. Usability is improved by way of allowing a user to predefine or configure ring tone volume behavior of a signaling device with sound signaling capability as described herein.

In accordance with one embodiment of the invention, program storage device readable by a machine, tangibly embodying a program of instructions executable by the machine to perform a method for increasing or decreasing a ring tone signal volume is provided. The method includes linearly increasing or decreasing a first volume of the ring tone signal over a first time period and linearly controlling a next volume of the ring tone signal over a next time period contiguous with the first time period. The method also includes non-linearly increasing or decreasing the ring tone signal volume over two contiguous time periods.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a block diagram of a phone incorporating features of the present invention;

FIG. 2 is a graphical diagram of the ring tone controller feature of the present invention shown in FIG. 1; and

FIG. 3 is a is a method flow chart showing steps for one method implementing features of the present invention shown in FIG. 1.

The detailed description explains the preferred embodiments of the invention, together with advantages and features, by way of example with reference to the drawings.

### DETAILED DESCRIPTION OF THE INVENTION

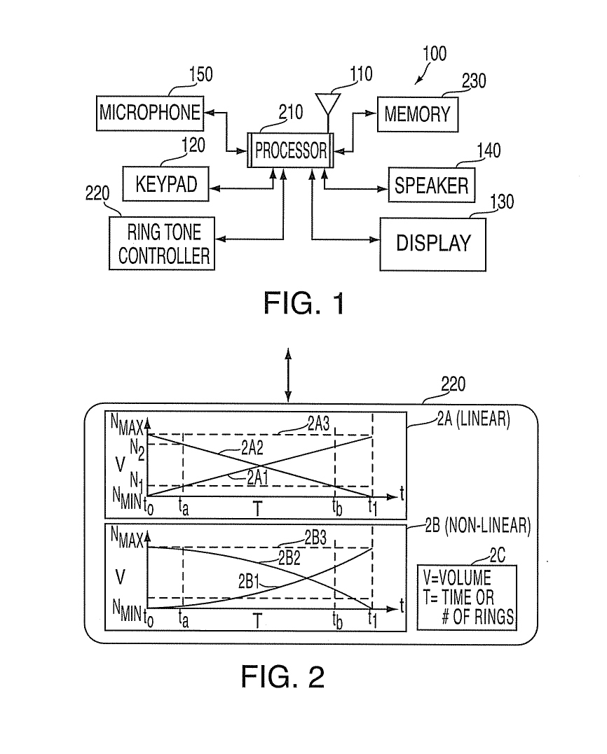

Turning now to FIG. 1, there is shown a block diagram of a phone 100 incorporating features of the present invention. It will be seen that in FIG. 1 there are input devices such as keypad 120 and microphone 150, as well as a display 130 and speaker 140 as output devices, further with an antenna 110 as both an input device and an output device. Phone 100 includes a processor 210 that is coupled to the antenna 110, keypad 120, display 130, speaker 140, and microphone 150. In addition, processor 210 is also coupled to a ring tone controller 220 and to a memory 230. Ring tone controller 220 is an electronic device that provides volume control signals to processor 210. Memory 230 may include any combination of volatile and non-volatile memory. Processor 210 takes input from keypad 120, microphone 150, ring tone controller 220, antenna 110′, and memory 230, and generates appropriate output on display 130, speaker 140, antenna 110, and memory 230.

Note that the block diagram of FIG. 1 does not include many components or features known in prior art portable phones. For clarity, the FIG. 1 diagram shows only commonly known components and features that allow a complete description of the preferred embodiments of the present invention. It will be appreciated that phone 100 could also include any component or feature that is known in the art in addition to those shown within the scope of the preferred embodiments. It will also be appreciated that the ring tone controller 220 shown in FIG. 1 may be used in any suitable phone or device having a ring tone, a signaling tone, or any suitable alerting signal, such as, for example, a cell phone, a land line phone, a paging device, or a personnel data assistant (PDA). It will be further appreciated that the signaling tone or alerting signal may also be a vibration mode of the device.

Turning also to FIG. 2, there is shown a graphical diagram of the ring tone controller 220 feature of the present invention shown in FIG. 1. Each of the graph axis are described by legend box 2C, where the y-axis V=volume and the x-axis T=time or number of rings. It will be appreciated that the controller functions described herein may be accomplished by any suitable means. For example, the controller functions may be preset selectable features programmed into memory 230 shown in FIG. 1, or may be programmed by a user via keypad 120, also shown in FIG. 1.

In general the ring tone controller 220 may be set to sound the ring tone sound as-is, gradually increase the volume over time, or gradually decrease the volume over time. FIG. 2 graph 2A shows each of these options.

Graph line 2A1 in linear volume controller 2A shows an increasing linear volume response graph volume (V) versus time (t) such that the ring tone starts at a nominal minimum volume value Nmin at time t₀. It will be appreciated that nominal minimum value Nmin may be pre-selected by user via keypad 120 or stored in memory 230. It will also be noted that the time axis t shown in FIG. 2 (items 2A and 2B) could also be in units of number of rings.

It will also be appreciated that the user may desire a discrete amount of time t₀-tₐ shown in linear volume controller 2A before the ring tone starts in order for a non-sound indicator (e.g., the display 130) to indicate an incoming signal or call. For example, volume Nmin may be set to 0 (i.e., sound is off) and at time tₐ the volume is set to level N₁. The time span t₀-tₐ (or number of rings) may be preset by the user via keypad 120 or stored in memory 230.

It will be further appreciated that the user may desire a discrete amount of time t₀-tₐ shown in linear volume controller 2A before the ring tone starts in order for a secondary ring tone to sound before the primary ring tone sounds to indicate an incoming signal or call. The time span t₀-tₐ (or number of rings) may be preset by the user via keypad 120 or stored in memory 230.

The high volume (i.e., V at Nmax shown in linear controller 2A) is reached at time t₁. Again, the time span t₀-t₁ (or number of rings) may be preset by the user via keypad 120 or stored in memory 230.

Graph line 2A2 in linear volume controller 2A shows a decreasing linear volume response graph volume (V) versus time (t) such that the ring tone starts at a maximum volume value Nmax at time t₀. It will be appreciated that nominal Nmax may be pre-selected by user via keypad 120 or stored in memory 230.

It will also be appreciated that the user may desire a discrete amount of time t₀-tₐ shown in linear volume controller 2A before the ring tone starts in order for a non-sound indicator (e.g., the display 130) to indicate an incoming signal or call. For example, volume Nmax may be set to off (i.e., sound is off) and at time tₐ the volume is set to level N₂. The time span t₀-tₐ (or number of rings) may be preset by the user via keypad 120 or stored in memory 230.

The minimum volume (i.e., V at Nmin shown in linear controller 2A) is reached at time t₁. Again, the time span t₀-t₁ (or tₐ-t₁) (or number of rings) may be preset by the user via keypad 120 or stored in memory 230. In other words, with the time span setting t₀-t₁ (or tₐ-t₁), the user can set the ring tone so that it is loud once (i.e., Nmax) and then falls rapidly to a low sound Nmin.

It will also be appreciated that the user may desire a discrete amount of time t_{b}-t₁ shown in linear volume controller 2A after the ring tone stops in order for a non-sound indicator (e.g., the display 130) to indicate the ring tone has stopped but before the phone switches to a voice messaging mode at the end of the ring tone cycle t₁. For example, volume N₁ may be set to off (i.e., sound is off) and at time t_{b} the volume is set to level N₁. The time span t_{b}-t₁ (or number of rings) may be preset by the user via keypad 120 or stored in memory 230.

Turning now to the non-linear volume controller 2B shown in FIG. 2: the non-linear volume controller operates similar to the linear volume controller 2A. However, it will be appreciated that human hearing is non-linear in nature and that a non-linear volume controller may be more adaptable to a user's hearing capability.

Although not shown (for purposes of clarity), the non-linear volume controller has the same features as described above for the linear controller. For example, graph line 2B1 in non-linear volume controller 2B shows an increasing linear volume response graph volume (V) versus time (t) such that a ring tone starts at a nominal minimum volume value Nmin at time t₀. It will be appreciated that nominal minimum value Nmin may be pre-selected by user via keypad 120 or stored in memory 230. It will also be noted that the time axis t shown in FIG. 2 (items 2A and 2B) could also be in units of number of rings.

It will also be appreciated that the user may desire a discrete amount of time t₀-tₐ shown in non-linear volume controller 2A before a ring tone starts in order for a non-sound indicator (e.g., the display 130) to indicate an incoming signal or call. For example, volume Nmin may be set to 0 (i.e., sound is off) and at time tₐ the volume is set to level N₁. The time span t₀-tₐ (or number of rings) may be preset by the user via keypad 120 or stored in memory 230.

It will be further appreciated that the user may desire a discrete amount of time t₀-tₐ shown in non-linear volume controller 2B before a ring tone starts in order for a secondary ring tone to sound before the primary ring tone sounds to indicate an incoming signal or call. The time span t₀-tₐ (or number of rings) may be preset by the user via keypad 120 or stored in memory 230.

The high volume (i.e., V at Nmax) shown in non-linear controller 2B is reached at time t₁. Again, the time span t₀-t₁ (or number of rings) may be preset by the user via keypad 120 or stored in memory 230.

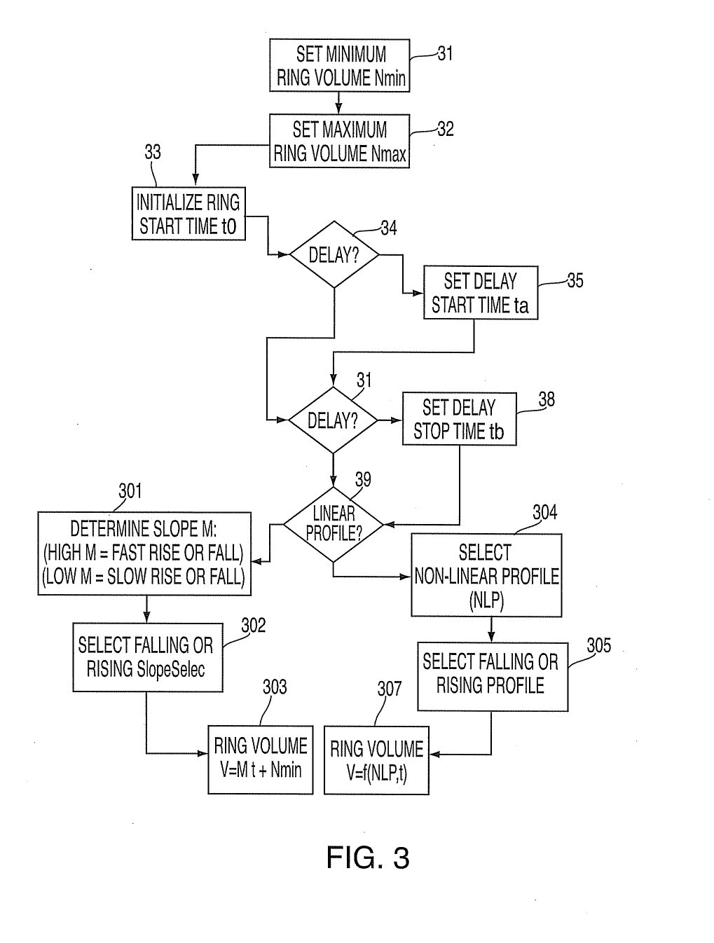

Referring also to FIG. 3 a flow chart shows steps for one method implementing features of the present invention shown in FIG. 1. Step 31 sets the user's desired minimum ring volume Nmin. Step 32 sets the user's desired maximum ring volume Nmax. Step 33 ring start time t₀ starts, or is initialized by a received call. Steps 34 and 35 allow a user to set a desired delay time before a ringing volume Nmin (or Nmax) is initialized. Similarly, Step 37 and Step 38 allow the user to set a stop or delay time t_{b} before the ring cycle end time t₁ is reached, allowing the user to set a final warning or signal that the ring cycle for the incoming call is about to end. Step 39 selects the user's preference for a linear or non-linear response profile as shown in FIG. 2. If a linear response is selected slope M is determined from the parameters Nmin, Nmax, t₀, and t₁ (or t_{b}). Alternatively the user could select a fast or slow rising or falling slope, step 301. In other words, for example, in step 301 the user can set how fast Nmin should reach Nmax. Step 302 determines if the slope is falling or rising, i.e., Nmax falling to Nmin, or Nmin rising to Nmax. Ring volume is determined by the linear relationship shown in step 303.

Still referring to FIG. 3, step 304 selects a non-linear profile function, e.g., f=(x)², or any other suitable profile function. It will be appreciated that the profile function may be stored in memory (FIG. 1, item 230) or entered by the user. Step 305 selects a falling or rising profile, similar to step 302. Ring volume is determined by the relationship shown in step 307.

It will be appreciated that advantages of the present invention allow a user to set the volume of a device initially low so that if the user can hear well, and the phone is near the user, it can be answered without disturbing others much before the volume gets louder.

Another advantage allows the user to set the volume initially high so the user can hear it right away but have it decrease. This is useful for persons who know they have a call because they just heard the ring it but the ring volume reduces so the ring does not annoy or interfere with others while the user is fiddling to answer the call.

Yet another advantage of the present invention is that there is no need to download or install a wave file that already has the increasing or decreasing sound as part of the captured wave file.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The diagrams depicted herein are just examples. There may be many variations to these diagrams described therein without departing from the spirit of the invention. The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A program storage device readable by a machine, tangibly embodying a program of instructions executable by the machine to perform a method for increasing or decreasing a ring tone signal volume, the method comprising:
linearly controlling a first volume of the ring tone signal over a first set period; and
linearly controlling a third volume of the ring tone signal over a third set period contiguous with the first set period.

2. The program storage device readable by a machine, tangibly embodying a program of instructions executable by the machine to perform a method for increasing or decreasing the ring tone signal volume as in claim 1, wherein linearly controlling the first volume of the ring tone signal over the first set period comprises linearly increasing or linearly decreasing the ring tone signal over the first set period.

3. The program storage device readable by a machine, tangibly embodying a program of instructions executable by the machine to perform a method for increasing or decreasing the ring tone signal volume as in claim 1, wherein linearly controlling the third volume of the ring tone signal over the third set period comprises linearly increasing or linearly decreasing the ring tone signal over the third set period.

4. The program storage device readable by a machine, tangibly embodying a program of instructions executable by the machine to perform a method for increasing or decreasing the ring tone signal volume as in claim 1, the method further comprising:
non-linearly controlling a second volume of the ring tone signal over a second set period; and
non-linearly controlling a fourth volume of the ring tone signal over a fourth set period contiguous with the second set period.

5. The program storage device readable by a machine, tangibly embodying a program of instructions executable by the machine to perform a method for increasing or decreasing the ring tone signal volume as in claim 4, wherein non linearly controlling a second volume of the ring tone signal over the second set period comprises non-linearly increasing or non-linearly decreasing the ring tone signal over the first set period.

6. The program storage device readable by a machine, tangibly embodying a program of instructions executable by the machine to perform a method for increasing or decreasing the ring tone signal volume as in claim 4, wherein non-linearly controlling the second volume of the ring tone signal over the fourth set period comprises non-linearly increasing or non-linearly decreasing the ring tone signal over the fourth set period.

7. A ring tone controller comprising:
a linear ring tone volume controller wherein the linear ring tone volume controller is adapted to linearly controlling a first volume of the ring tone signal over a first set period and wherein the linear ring tone volume controller is adapted to linearly controlling a third volume of the ring tone signal over a third set period contiguous with the first set period; and
a non-linear ring tone volume controller wherein the non-linear ring tone volume controller is adapted to non-linearly controlling a second volume of the ring tone signal over a second set period and wherein the non-linear ring tone volume controller is adapted to non-linearly controlling a fourth volume of the ring tone signal over a fourth set period contiguous with the second set period.

8. The ring tone controller as in claim 7 wherein the linear ring tone volume controller is adapted to linearly increase the volume of the ring tone signal over the first set period.

9. The ring tone controller as in claim 7 wherein the linear ring tone volume controller is adapted to linearly decrease the volume of the ring tone signal over the first set period.

10. The ring tone controller as in claim 7 wherein the non-linear ring tone volume controller is adapted to non-linearly increase the volume of the ring tone signal over the second set period.

11. The ring tone controller as in claim 7 wherein the non-linear ring tone volume controller is adapted to non-linearly decrease the volume of the ring tone signal over the second set period.

12. The ring tone controller as in claim 7 wherein the linear ring tone volume controller is adapted to linearly increase the volume of the ring tone signal over the third set period.

13. The ring tone controller as in claim 7 wherein the linear ring tone volume controller is adapted to linearly decrease the volume of the ring tone signal over the third set period.

14. The ring tone controller as in claim 7 wherein the non-linear ring tone volume controller is adapted to non-linearly increase the volume of the ring tone signal over the fourth set period.

15. The ring tone controller as in claim 7 wherein the non-linear ring tone volume controller is adapted to non-linearly decrease the volume of the ring tone signal over the fourth set period.

16. A device having an alerting signal, the device comprising:
a processor;
a keypad coupled to the processor;
a microphone coupled to the processor;
a memory coupled to the processor;
a speaker coupled to the processor;
a display coupled to the processor;
an antenna coupled to the processor; and
an alerting signal controller coupled to the processor wherein alerting signal controller comprises:
a linear ring tone volume controller wherein the linear ring tone volume controller is adapted to linearly controlling a first magnitude of the alerting signal over a first set period and wherein the linear ring tone volume controller is adapted to linearly controlling a third magnitude of the alerting signal over a third set period contiguous with the first set period and wherein the linear ring tone volume controller is adapted to:
linearly increasing or decreasing the magnitude of the alerting signal over the first set period;
linearly increasing or decreasing the magnitude of alerting signal over the third set period;
a non-linear ring tone volume controller wherein the non-linear ring tone volume controller is adapted to non-linearly controlling a second magnitude of the alerting signal over a second set period and wherein the non-linear ring tone volume controller is adapted to non-linearly controlling a fourth magnitude of the alerting signal over a fourth set period contiguous with the second set period and wherein the non-linear ring tone volume controller is adapted to:
non-linearly increasing or decreasing the magnitude of the alerting signal over the second set period; and
non-linearly increasing or decreasing the magnitude of the alerting signal over the fourth set period.

17. The device as in claim 16 further comprising a cell phone.

18. The device as in claim 16 further wherein the alerting signal comprises a vibration mode.

19. The device as in claim 16 further comprising a personnel data assistant (PDA).

20. The device as in claim 16 further comprising a pager.
